(19) United States
(12) Patent Application Publication
(10) Pub. No.: US 2021/0397227 A1
(43) Pub. Date: Dec. 23, 2021

(54) FOLDABLE ELECTRONIC DEVICE

(71) Applicant: Acer Incorporated, New Taipei City (TW)

(72) Inventors: Yi-Ta Huang, New Taipei City (TW); Wu-Chen Lee, New Taipei City (TW); Cheng-Nan Ling, New Taipei City (TW); Wen-Chieh Tai, New Taipei City (TW)

(73) Assignee: Acer Incorporated, New Taipei City (TW)

(21) Appl. No.: 17/182,238

(22) Filed: Feb. 23, 2021

(30) Foreign Application Priority Data
Jun. 22, 2020 (TW) 109121052

(51) Int. Cl. G06F 1/16

(52) U.S. Cl. CPC G06F 1/1681; G06F 1/1616

(57) ABSTRACT

A foldable electronic device including a hinge module and a pair of bodies is provided. The hinge module is connected between the bodies such that the bodies may rotate relatively to be folded or unfolded. The hinge module includes a first torsion member and a second torsion member linked respectively to the bodies to generate torsional forces during a travel of a rotation of the bodies to be folded or unfolded. The first torsion member generates torsional force in a first section of the travel, the second torsion member generates torsional force in a second section of the travel, and the first section and the second section overlap partially, in which the direction of the first torsion member is opposite to the direction of the second torsion member.

### CROSS-REFERENCE TO RELATED APPLICATION

This application claims the priority benefit of Taiwan application serial no. 109121052, filed on Jun. 22, 2020. The entirety of the above-mentioned patent application is hereby incorporated by reference herein and made a part of this specification.

### BACKGROUND

### Technical Field

The disclosure relates to a foldable electronic device.

### Description of Related Art

A hinge module of a foldable electronic device is disposed between two bodies (for example, a screen and a host computer) such that the two may rotate relatively to be folded or unfolded and that the required support of the host computer may be provided. Due to various needs, a variety of functions has also been developed for the hinge module, such as automatic locking, light-opening-and-heavy-closing, blockage, anti-shaking, etc.

However, as the foldable electronic device is designed to be lighter, thinner, and smaller, the hinge module in turn causes difficulties in unfolding the bodies. For example, due to the limit in torsional force of the hinge module, it is difficult for the user to unfold the bodies with one hand. Therefore, the hinge module is facing the above predicament, that is, how to maintain the torsional force required to support the bodies while also preserving the user's convenience. This is an issue for those skilled in the art to ponder and to solve.

### SUMMARY

Accordingly, the disclosure provides a foldable electronic device, which provides different torsional forces during the rotation of the bodies to be folded or unfolded via different torsion members of the hinge module, which is designed for the operational convenience for the user.

The foldable electronic device of the disclosure includes a hinge module and a pair of bodies. The hinge module is connected between the bodies such that the bodies may rotate relatively to be folded or unfolded. The hinge module includes a first torsion member and a second torsion member linked respectively to the bodies to generate torsional force during a travel of a folding/unfolding rotation. The first torsion member generates torsional force in a first section of the travel, the second torsion member generates torsional force in a second section of the travel, and the first section and the second section overlap partially, in which the direction of torsional force generated by the first torsion member is opposite to the direction of torsional force generated by the second torsion member.

Based on the above, the hinge module has a first torsion member and a second torsion member linked respectively to the pair of the bodies of the foldable electronic device. Also, the first torsion member and the second torsion member provide torsional forces in different sections during the travel of the relative rotation of the bodies to be folded or unfolded. And the sections where torsional forces are generated overlap partially, and the directions of the torsional forces are opposite to each other, such that the hinge module may create a predetermined angles accordingly for the bodies to be folded and unfolded. By designing so, the predetermined angles of the folded or unfolded bodies created by disposing different torsion members may assist the user in folding or unfolding the bodies, such that the user may experience the effects of effort-saving and handiness when performing relevant motions.

### BRIEF DESCRIPTION OF THE DRAWINGS

FIG. 1 is a schematic view of a foldable electronic device according to an embodiment of the disclosure.

FIGS. 2A and 2B are exploded-view drawings of a hinge module illustrated from different angles.

FIG. 3 is a schematic view of the hinge module according to FIG. 1 in another condition.

FIG. 4 is a diagram of the simple correspondence between torsional forces and the travels of the folding/unfolding rotation.

FIG. 5 is a diagram of the corresponding relations between torsional forces generated by the first torsion member and the second torsion member and the folding/unfolding angles of the bodies.

FIG. 6A is a schematic view of a foldable electronic device according to another embodiment of the disclosure.

FIG. 6B is a diagram of the partially enlarged hinge module shown in FIG. 6A.

FIG. 7A is a schematic view of a foldable electronic device according to another embodiment of the disclosure.

FIG. 7B is a diagram of the partially enlarged hinge module shown in FIG. 7A.

FIG. 8A is a schematic view of a foldable electronic device according to another embodiment of the disclosure.

FIG. 8B is a diagram of the partially enlarged hinge module shown in FIG. 8A.

### DESCRIPTION OF THE EMBODIMENTS

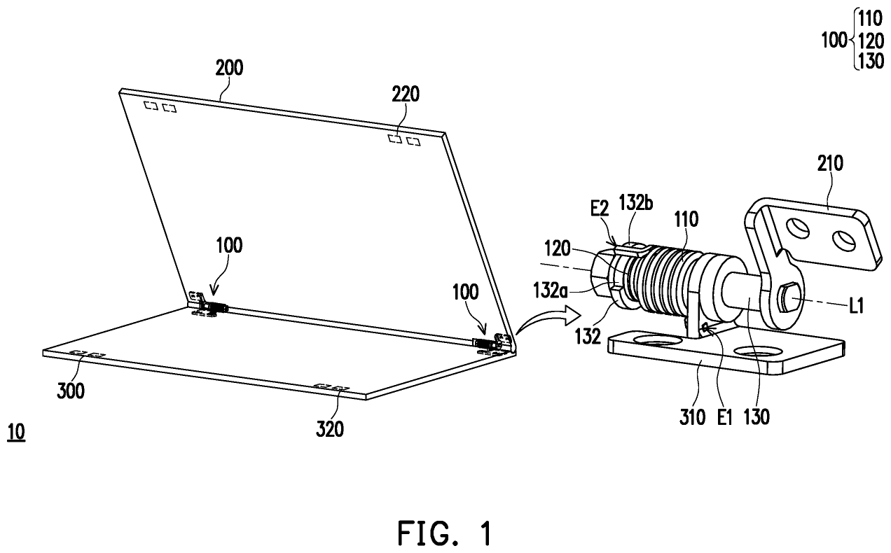

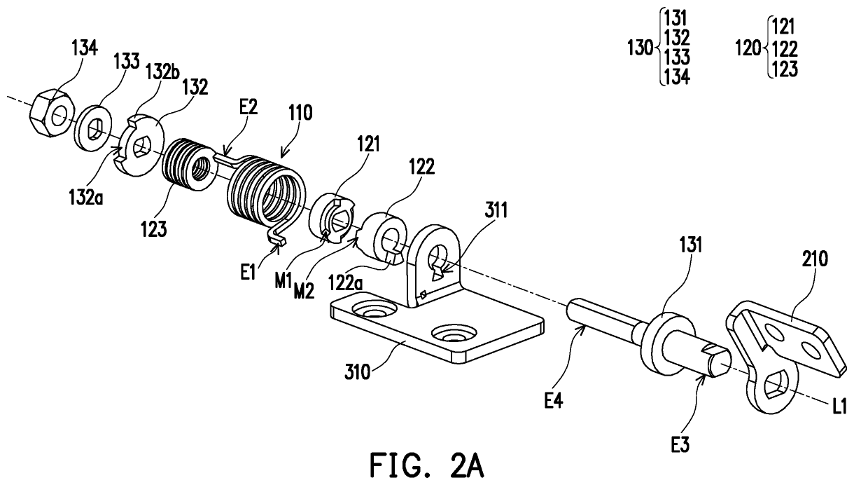

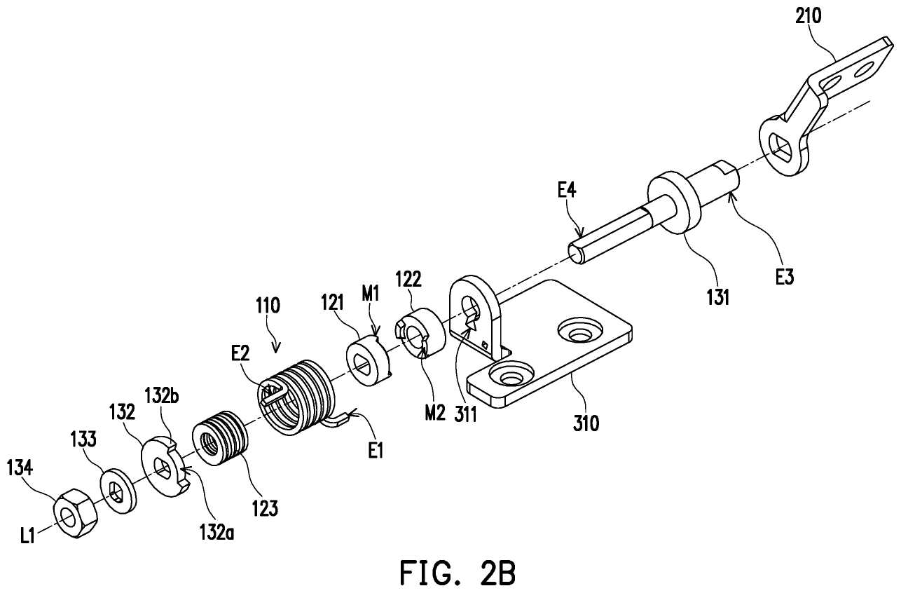

FIG. 1 is a schematic view of a foldable electronic device according to an embodiment of the disclosure. FIGS. 2A and 2B are exploded-view drawings of a hinge module illustrated from different angles. Referring to FIG. 1, FIG. 2A, and FIG. 2B, in the present embodiment, a foldable electronic device 10 includes a hinge module 100 and a pair of bodies 200 and 300. The hinge module 100 is connected between the bodies 200 and 300 such that the bodies 200 and 300 may rotate relatively to each other to be folded or unfolded. The hinge module 100 includes a first torsion member 110 and a second torsion member 120 linked respectively to the bodies 200 and 300 to generate torsional force during a travel of a folding/unfolding rotation. As shown in FIG. 1, a pair of the hinge modules 100 is disposed between the bodies 200 and 300. Hereinafter one of the hinge modules 100 is to be taken as an example, and the explanatory details of the other hinge module 100 with the same structure and function is thereby omitted.

Referring to both FIG. 2A and FIG. 2B, in the present embodiment, the bodies 200 and 300 have a first bracket 210 and a second bracket 310. The hinge module 100 further includes a pivot 130, which is disposed to the first bracket 210 and rotates synchronously with the first bracket 210 on a rotation axis L1. The pivot 130 is disposed to penetrate the second bracket 310, and the second torsion member 120 is sleeved on the pivot 130 and abuts the second bracket 310.

Specifically speaking, the pivot 130 includes a shaft portion 131, an abutting member 132, a limiting member 133, and a locking attachment 134. The second torsion member 120 is composed of a plurality of torsion units 121, 122, and 123, in which an end E3 of the shaft portion 131 is fixed to the first bracket 210 and the other end E4 of the shaft portion 131 is disposed to penetrate the second bracket 310, the torsion units 122, 121, and 123, the abutting member 132, the limiting member 133, and the locking attachment 134 in sequence. As shown in the figures, the torsion unit 122 is fixed to the second bracket 310 by joining a convex portion 122a and a groove 311 together. And after the limiting member 133 and the locking attachment 134 are assembled to the shaft portion 131, the torsion units 121 to 123 may be fixed coaxially between the second bracket 310 and the abutting member 132 to form a tight fit, and the friction generated between the torsion units 121 to 123 are further converted into torsional force of the pivot 130 rotating on the rotation axis L1. As shown in the figures, the torsion unit 121 is fixed to the shaft portion 131 and rotates synchronously with the shaft portion 131, and the torsion units 121 and 122 have cam structures M1 and M2 opposite to each other. Therefore, when the pivot 130 rotates, the torsion units 121 and 122 shift relatively along the rotation axis L1 due to the cam structures M1 and M2, which in turn generates the aforementioned friction.

Furthermore, after the second torsion member 120 of the present embodiment is assembled to the pivot 130 as described above, the first torsion member 110 is sleeved on the pivot 130 to surround the pivot 130 and the second torsion member 120. The first torsion member 110 has an end E1 fixed to the second bracket 310 and the other end E2 extending to the abutting member 132, and the abutting member 132 is fixed substantially to the other end E4 of the shaft portion 131 to rotate with the shaft portion 131, making the other end E2 of the first torsion member 110 be on the rotation path of the abutting member 132. As shown in FIG. 1 and FIG. 2A, the abutting member 132 has a notch 132a to which the other end E2 may extend, and the notch also allows the other end E2 to abut against a step portion 132b of the abutting member 13 when the foldable electronic device 10 is unfolded as shown in FIG. 1.

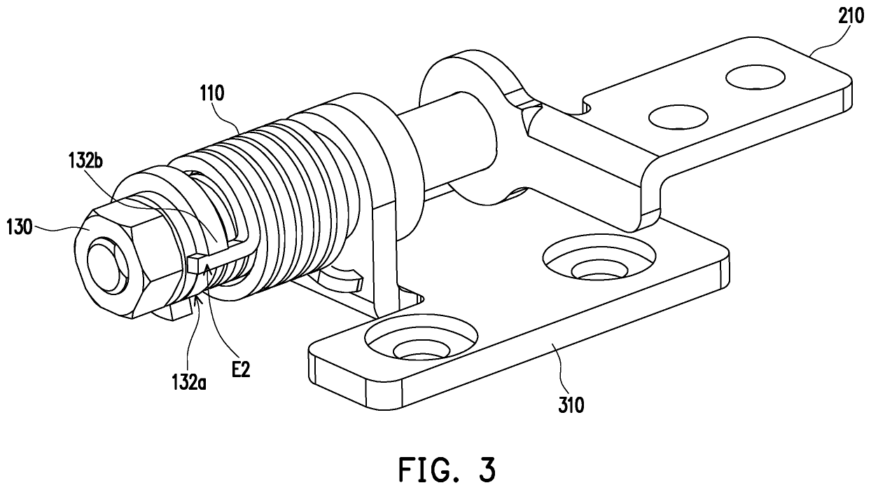

FIG. 3 is a schematic view of the hinge module according to FIG. 1 in another condition. Referring to both FIG. 1 and FIG. 3, when the foldable electronic device 10 transits from the unfolded condition of FIG. 1 to the fully folded condition of FIG. 3, the pivot 130 rotates with the body 200 (the first bracket 210). In terms of the first torsion member 110, the abutting member 132 rotates with the shaft portion 131, such that the other end E2 of the first torsion member 110 is driven to the position shown in FIG. 3 by the abutting member 132, which causes the first torsion member 110 to deform and accumulate elasticity. Conversely, it is also the elasticity accumulated enough by the first torsion member 110 that makes the bodies 200 and 300 to be unfolded as in the condition shown in FIG. 1. For example, the foldable electronic device 10 further includes locking mechanisms 220 and 320 (illustrated in FIG. 1) which are disposed to the bodies 200 and 300, and examples of the locking mechanisms may be magnetic components that attract each other magnetically, or a latch assembly which provides the effect of locking when the bodies 200 and 300 are fully folded as shown in FIG. 3, thereby maintaining the bodies 200 and 300 in fully folded condition. Once the effect of locking is dismissed, the bodies 200 and 300 may be driven by the elasticity accumulated by the first torsion member 110 and restore to the condition shown in FIG. 1. In other words, the unfolding angle of the bodies 200 and 300 shown in FIG. 1 may be regarded as the predetermined unfolding angle of the foldable electronic device 10 achieved by the first torsion member 110.

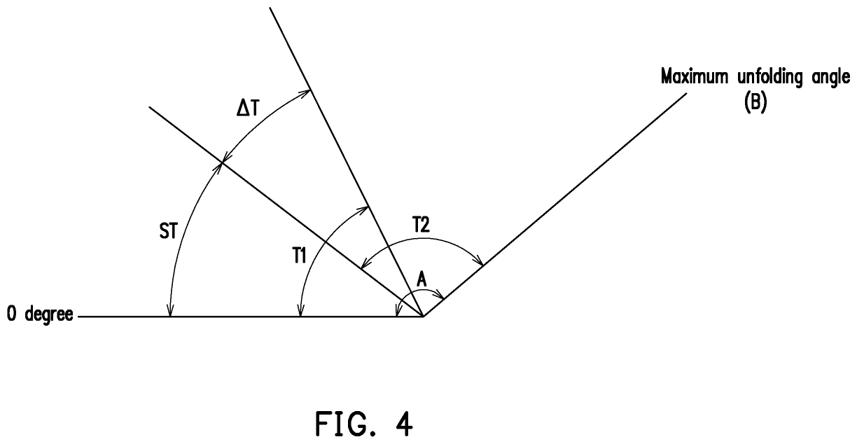

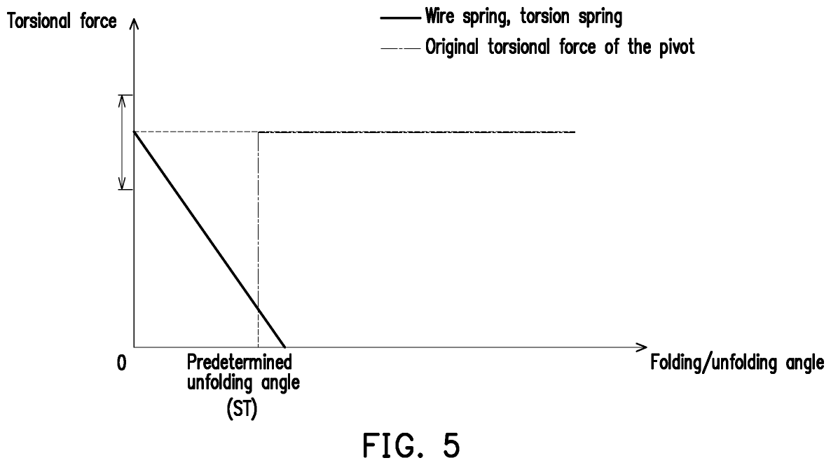

FIG. 4 is a diagram of the simple correspondence between torsional forces and the travels of the folding/unfolding rotation. FIG. 5 is a diagram of the corresponding relations between torsional forces generated by the first torsion member and the second torsion member and the folding/unfolding angles of the bodies. Here, the travels of the folding/unfolding rotation are the corresponding angles for the bodies 200 and 300 to be folded or unfolded. Referring to both FIG. 4 and FIG. 5, in the present embodiment, the travels of the folding/unfolding rotation of the bodies 200 and 300 of the foldable electronic device 10 are shown in FIG. 4, in which the first torsion member 110 is adapted to generate torsional force in a first section T1 of the travel, the second torsion member 120 is adapted to generate torsional force in a second section T2 of the travel, the first section T1 and the second section T2 overlap partially (the overlapping travel is ΔT), and the direction of torsional force generated by the first torsion member 110 is opposite to the direction of torsional force generated by the second torsion member 120. In other words, as shown in FIG. 5, after the first torsion member 110 is disposed as described above, it generates the maximum torsional force when the bodies 200 and 300 are fully folded (that is, when the travel of the folding/unfolding rotation is at 0 degree), and the second torsion member 120 generates torsional force for supporting the bodies 200 and 300 only after the folding/unfolding rotation travels from 0 degree to a certain degree.

Furthermore, the bodies 200 and 300 in fully folded condition are regarded as the starting point of the travel, the bodies 200 and 300 in fully unfolded condition are regarded as the end of the travel (i.e., the maximum unfolding angle as shown in FIG. 4), the first section T1 includes the starting point, the second section T2 includes the end, and the first section T1 from which the partially overlapping section (the overlapping travel is ΔT) is deducted then forms the predetermined unfolding angle ST of the bodies 200 and 300. Simply put, the total travel of the folding/unfolding rotation is A, and the maximum unfolding angle of the bodies 200 and 300 is B, in which 0°≤A≤B, and the first section of the travel is T1, the second section of the travel is T2, in which 0°≤T1<B, 0°<T2≤B, and ST+T2=A. In the present embodiment, the weight of the bodies 200 and 300 is required to be taken into consideration to generate the overlapping travel ΔT. The purpose is to allow the bodies 200 and 300 to be unfolded smoothly as well as being unfolded smoothly in the reverse direction, that is, the purpose of the overlapping travel ΔT is to allow the torsional force generated by the second torsion member 120 to assist the user to overcome the first torsion member 110 and drive smoothly the bodies 200 and 300 to be fully folded, thereby providing the effort-saving effect.

It should be noted further that the present embodiment does not limit the torsional force of the first torsion member 110 when the folding/unfolding angle is at 0 degree. The torsional force of the first torsion member 110 may be greater than, equal to, or less than the torsional force generated by the second torsion member according to needs, as it is shown by the double-sided arrow on the vertical axis in FIG. 5. In other words, it can be adjusted suitably according to the usage conditions of the foldable electronic device 10 and the weight of the bodies 200 and 300.

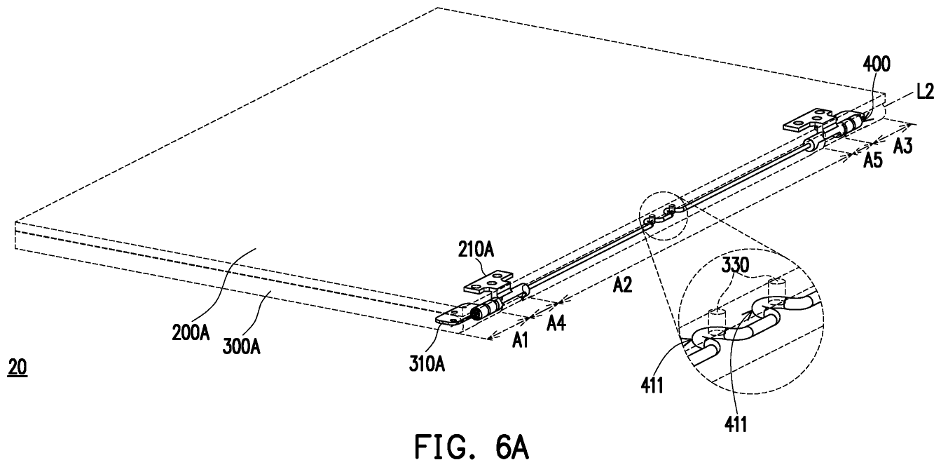

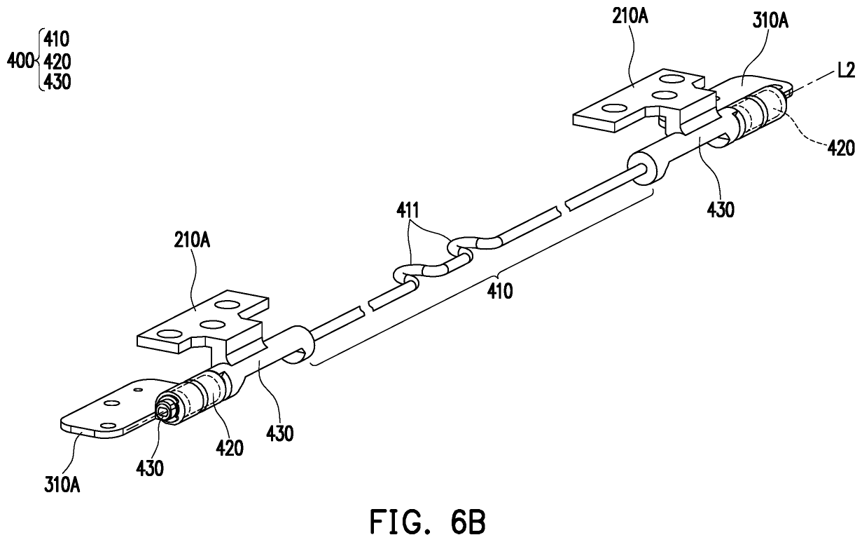

FIG. 6A is a schematic view of a foldable electronic device according to another embodiment of the disclosure. FIG. 6B is a diagram of the partially enlarged hinge module shown in FIG. 6A, in which a first torsion member 410 is partially omitted for the ease of recognition. Referring to both FIGS. 6A and 6B, in the present embodiment, a hinge module 400 of a foldable electronic device 20 has the first torsion member 410, a second torsion member 420, and a pivot 430. And, along a rotation axis L2 of the hinge module 400, the bodies 200A and 300A have a five-section structure, which respectively are a part I A1, a part II A2, and a part III A3 of the body 300A having the second bracket 310A as well as a part IV A4 and a part V A5 of the body 200A having the first bracket 210A. They are arranged in the following order: the part I A1, the part IV A4, the part II A2, the part V A5, and the part III A3, in which different parts of the first torsion member 410 are connected respectively to the pivot 430 and the body 300A having the second bracket 310A.

In other words, as shown in FIG. 6A, the center of the first torsion member 410 is fixed to the body 300A having the second bracket 310A via the mutual hold between protruding columns 330 disposed in the part II A2 of the body 300A and bending portions 411. Furthermore, the two opposite ends of the first torsion member 410 are fixed respectively to the pivot 430. And in the present embodiment, the pivot 430 is disposed to the first bracket 210A and rotates synchronously therewith, so when the bodies 200A and 300A rotate relatively on the rotation axis L2, the first torsion member 410 is deformed and accumulates elasticity, thereby achieving the effects shown in FIG. 4 and FIG. 5 as in the foregoing embodiments. Here, as the second torsion member 420 has the same configuration of components and the same effect as the second torsion member 120 of the foregoing embodiment, its details will not be repeated again. The pivot 430 is disposed to penetrate the second bracket 310A, and the second torsion member 420 abuts between the pivot 430 and the second bracket 310A to generate the required torsional force, and the first torsion member 410 and the second torsion member 420 are opposite to each other with the first bracket 210A in between.

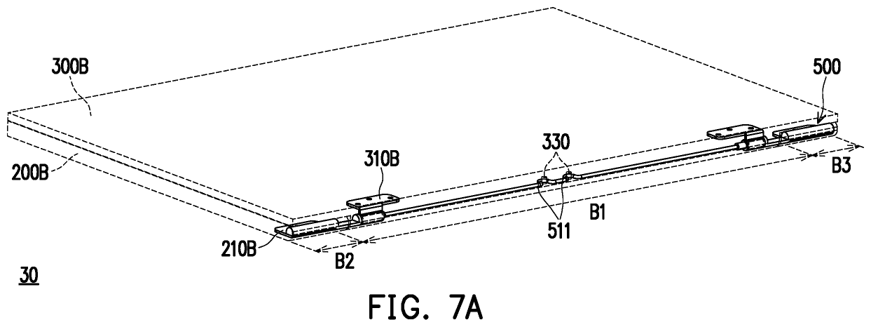

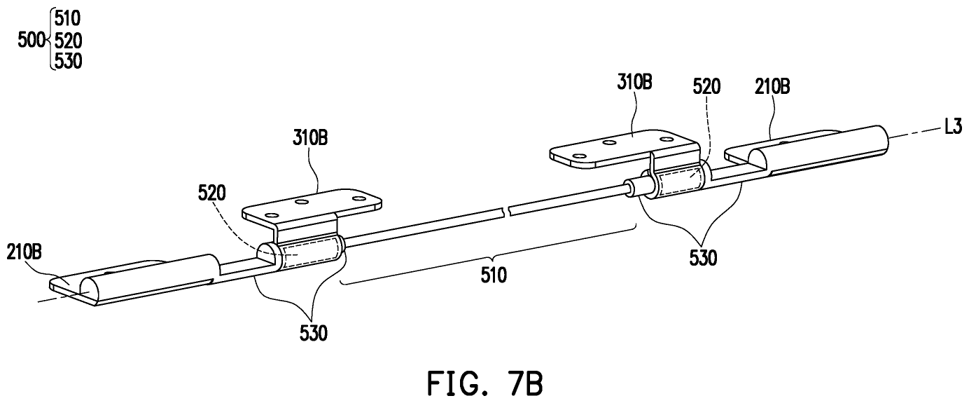

FIG. 7A is a schematic view of a foldable electronic device according to another embodiment of the disclosure. FIG. 7B is a diagram of the partially enlarged hinge module shown in FIG. 7A, in which a first torsion member 510 is partially omitted for the ease of recognition. Referring to both FIGS. 7A and 7B, in the present embodiment, a hinge module 500 of a foldable electronic device 30 has the first torsion member 510, a second torsion member 520, and a pivot 530. And, along a rotation axis L3 of the hinge module 500, the bodies 200B and 300B have a three-section structure, which respectively are a part I B1 of the body 300B having the second bracket 310B, a part II B2 located at the body 200B, and a part III B3, in which the part I B1 is located between the part II B2 and the part III B3. Here, similarly, the center of the first torsion member 510 is fixed to the part I B1 via the mutual hold between bending portions 511 and protruding columns 330 of the body 300B, and the pivot 530 is disposed to the first bracket 210B of the body 200B and rotates synchronously therewith, and is connected to an end of the first torsion piece 510 after penetrating the second bracket 310B. Accordingly, when the bodies 300B and 200B rotate relatively on the rotation axis L3, the first torsion member 510 is deformed and accumulates elasticity, thereby achieving the effects as shown in FIG. 4 and FIG. 5 of the foregoing embodiments. Here, as the second torsion member 520 has the same configuration of components and the same effect as the second torsion member 120 of the foregoing embodiment, its details will not be repeated again.

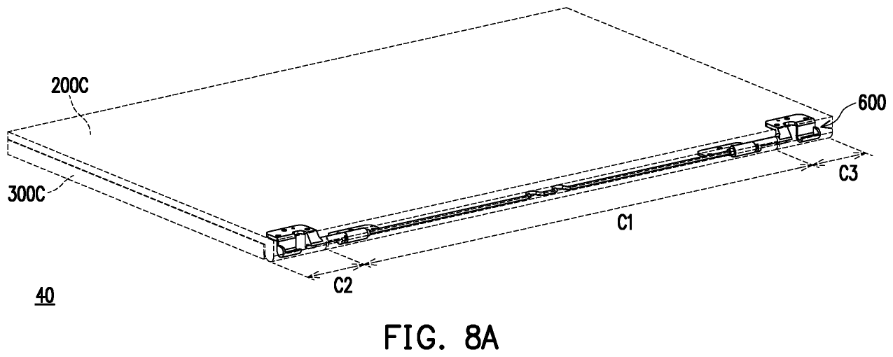

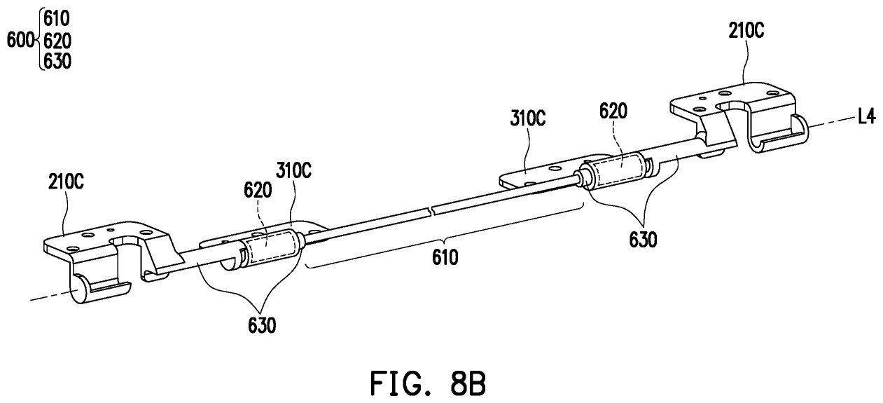

FIG. 8A is a schematic view of a foldable electronic device according to another embodiment of the disclosure. FIG. 8B is a diagram of the partially enlarged hinge module shown in FIG. 8A, in which a first torsion member 610 is partially omitted for the ease of recognition. Referring to both FIG. 8A and FIG. 8B, in the present embodiment, a hinge module 600 of a foldable electronic device 40 has the first torsion member 610, a second torsion member 620, and a pivot 630. And, along a rotation axis L4 of the hinge module 600, the bodies 200C and 300C have a three-section structure, which are a part I C1 of the body 300B having the second bracket 310C, a part II C2 located at the body 200C, and a part III C3, in which the part I C1 is located between the part II C2 and the part III C3. Here, similarly, the center of the first torsion member 610 is fixed to the part I C1 via the mutual hold between the bending portions and the protruding columns (which is the same as the previous embodiments, and thus the description and labels are not laid out redundantly herein), and the pivot 630 is disposed to the first bracket 210C of the body 200C and rotates synchronously therewith, and is connected to an end of the first torsion member 610 after penetrating the second bracket 310C. Accordingly, when the bodies 300C and 200C rotate relatively on the rotation axis L4, the first torsion member 610 is deformed and accumulates elasticity, thereby achieving the effects as shown in FIG. 4 and FIG. 5 of the foregoing embodiments. Here, as the second torsion member 620 (abutting between the pivot 630 and the first bracket 210C) has the same configuration of components and the same effect as the second torsion member 120 of the foregoing embodiment, its details will not be repeated again.

In sum, in the above embodiments of the disclosure, a hinge module has a first torsion member and a second torsion member linked respectively to a pair of bodies of a foldable electronic device. Also, the first torsion member and the second torsion member provide torsional forces in different sections during the travel of a relative rotation of the bodies to be folded or unfolded. The sections where the torsional forces are generated overlap with each other partially, and the directions of the torsional forces are opposite to each other, such that the hinge module may create a predetermined folding/unfolding angle of the bodies.

In the above embodiments, the pivot is disposed to the first bracket and rotates synchronously therewith, and then the pivot is disposed to penetrate the second bracket and have the second torsion member abuts between the pivot and the second bracket. Meanwhile, in terms of the bodies, by incorporating the setting of different torsional forces mentioned above, the first torsion member is disposed to direct the bodies from being folded fully to being unfolded at the predetermined unfolding angle, and the second torsion member is disposed to direct the bodies from being unfolded at the predetermined unfolding angle to being unfolded at the maximum unfolding angle. This is equivalent to having the second torsion member to travel without torsional force during the travel in which the bodies are directed from being folded fully to being unfolded at the predetermined unfolding angle.

By designing so, the predetermined folding/unfolding angles created by disposing different torsion members may assist the user in folding or unfolding the bodies, such that the user may experience the effects of effort-saving and handiness when performing relevant motions.

What is claimed is:

1. A foldable electronic device, comprising:
a pair of bodies; and
a hinge module, connected between the pair of bodies such that the pair of bodies may rotate relatively to each other to be folded or unfolded via the hinge module, the hinge module comprising a first torsion member and a second torsion member linked respectively to the pair of bodies to generate torsional force during a travel of a folding/unfolding rotation, wherein the first torsion member generates torsional force in a first section of the travel, the second torsion member generates torsional force in a second section of the travel, and the first section and the second section have a partially overlapping section, and a direction of torsional force generated by the first torsion member is opposite to a direction of torsional force generated by the second torsion member.

2. The foldable electronic device according to claim 1, wherein the pair of bodies in fully folded condition is regarded as a starting point of the travel, the pair of bodies in fully unfolded condition is regarded as an end of the travel, the first section comprises the starting point, the second section comprises the end, and the first section from which the partially overlapping section is deducted forms a predetermined unfolding angle of the pair of bodies.

3. The foldable electronic device according to claim 1, wherein the travel is A, and a maximum unfolding angle of the pair of bodies is B, 0°≤A≤B, the first section of the travel is T1, the second section of the travel is T2, 0°≤T1<B, and 0°<T2≤B.

4. The foldable electronic device according to claim 3, wherein the partially overlapping section of the first section and the second section is ΔT, a predetermined unfolding angle of the pair of bodies formed by deducting the partially overlapping section from the first section is ST, ST=T1−ΔT, and ST+T2=A.

5. The foldable electronic device according to claim 1, further comprising a locking mechanism, disposed to the pair of bodies to maintain the pair of bodies in a fully folded condition.

6. The foldable electronic device according to claim 1, wherein the pair of bodies comprises respectively a first bracket and a second bracket, and the hinge module further comprises:
a pivot, disposed to the first bracket and rotating synchronously with the first bracket, and penetrating the second bracket, wherein the second torsion member is sleeved on the pivot and abuts the second bracket.

7. The foldable electronic device according to claim 6, wherein an end of the first torsion member is fixed to the second bracket, the pivot comprises an abutting member, the other end of the first torsion member is on a rotation path of the abutting member, when the pair of bodies is in fully folded condition the abutting member abuts and causes the first torsion member to deform and to accumulate elasticity, and the elasticity is adapted to pass via the pivot and drive the pair of bodies to rotate relatively to be unfolded to a predetermined unfolding angle.

8. The foldable electronic device according to claim 6, wherein the first torsion member surrounds the second torsion member and the pivot.

9. The foldable electronic device according to claim 6, wherein different parts of the first torsion member are connected respectively to the pivot and the pair of body comprising the second bracket.

10. The foldable electronic device according to claim 9, wherein along a rotation axis of the hinge module, the pair of bodies has a three-section structure, comprising a part I of the body comprising the second bracket, a part II located at the other body, and a part III, wherein the part I is located between the part II and the part III, a center of the first torsion member is fixed to the part I, and the pivot is connected to an end of the first torsion member after penetrating the second bracket.

11. The foldable electronic device according to claim 9, wherein along a rotation axis of the hinge module, the pair of bodies has a five-section structure, comprising a part I, a part II, and a part III of the body having the second bracket as well as a part IV and a part V of the other body, which are arranged in the following order: the part I, the part IV, the part II, the part V, and the part III, and a center of the first torsion member is fixed to the part II.

12. The foldable electronic device according to claim 11, wherein the first torsion member and the second torsion member are opposite to each other with the first bracket in between.
